(19) United States
(12) Patent Application Publication
(10) Pub. No.: US 2007/0221460 A1
(43) Pub. Date: Sep. 27, 2007

(54) Vibration damping device for internal combustion engine

(75) Inventors: Shijie Guo, Komaki-shi (JP); Atsushi Muramatsu, Komaki-shi (JP); Yoshinori Yasumoto, Kasugai-shi (JP); Takehiro Yamada, Inazawa-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., KOMAKI-SHI (JP)

(21) Appl. No.: 11/715,982

(22) Filed: Mar. 9, 2007

(30) Foreign Application Priority Data
Mar. 23, 2006 (JP) 2006-080142

(51) Int. Cl. F16F 7/10

(52) U.S. Cl. 188/378

(57) ABSTRACT

A vibration damping device for use in an internal combustion engine including: a rigid housing having a hollow space; an independent mass member housed within the hollow space; and at least one rubber sleeve being independent of the housing and the mass member and being disposed within an empty space between the housing and the mass member so as to extend over an entire circumference of the empty space with a constant thickness dimension. An inside tiny gap is formed between an inner circumferential surface of the rubber sleeve and an outer surface of the mass member over an entire circumference thereof, while an outside tiny gap is formed between an outer circumferential surface of the rubber sleeve and an inner surface of the housing over an entire circumference thereof at room temperature of 25° C.

### INCORPORATED BY REFERENCE

The disclosure of Japanese Patent Application No. 2006-080142 filed on Mar. 23, 2006 including the specification, drawings and abstract is incorporated herein by reference in its entirety.

### BACKGROUND OF THE INVENTION

1. Field of the Invention

The present invention relates generally to vibration damping devices each having an independent mass member housed within a housing and attains vibration damping action on the basis of striking action of the independent mass member against the housing in association with resilient displacement of the independent mass member. More particularly, the present invention pertains to a vibration damping device suitable for use in an automotive engine mount, a muffler support, and other possible components in an internal combustion engine.

2. Description of the Related Art

As one type of vibration damping devices, there is known a resilient type vibration damping device including: a housing fixed to a target whose vibration is to be damped; and an independent mass member accommodated within the housing so as to be displaceable in a resilient fashion with respect to the housing. This type of vibration damping device will exhibit damping effect utilizing collision energy or attenuating action generated by repeated striking or collision of the independent mass member against the housing in association with the resilient displacement of the independent mass member within the housing during input of vibrational load. U.S. Pat. No. 6,439,359 discloses one example of such device.

There is a demand for the resilient type vibration damping device as described above to be further improved in terms of a vibration damping capability. Specifically, the device has been requested to improve its attenuation capability, thereby further effectively attaining its vibration damping capability, while being requested to exhibit effective vibration damping action in a wide vibration frequency band. To meet these demands, the inventors conducted extensive studies and have found that it is effective to form a rubber elastic layer of substantially unchanging thickness on at least one of the outer surface of the. independent mass member and the inner surface of the housing as seen in transverse cross section, and to form a spacing of substantially unchanging size between the outer surface of the independent mass member and the inner surface of the housing over the entire circumference thereof as seen in transverse cross section. The inventors also have found that the spacing should preferably be a tiny space with a small size.

The reason why the construction as described above is effective to improve vibration damping action might be assumed, for example, as follows: (1) the rubber elastic layer is more likely to undergo shearing deformation as well as compressive deformation when the independent mass member strikes against the housing; (2) friction is effectively produced during contact between the independent mass member and the housing; and (3) the independent mass member strikes against the housing on opposite sides thereof in the resilient displacement direction.

However, the inventors have discovered that the vibration damping device of conventional structure wherein the outer surface of the independent mass member and the inner surface of the housing are opposed to each other with the tiny space therebetween via the rubber elastic layer, may be insufficient for exhibiting desired damping effect with stability, in the case where the device is used as a vibration damping device for use in a component of an internal combustion engine, such as an automotive engine mount or muffler support.

### SUMMARY OF THE INVENTION

It is therefore one object of this invention to provide a resilient-displacement type vibration damping device for use in an internal combustion engine, wherein the vibration damping device is novel in construction so that it can consistently attain the desired vibration damping action.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

The principle of the present invention provides a vibration damping device for use in an internal combustion engine, comprising: a rigid housing having a hollow space, and adapted to be fixed to a target member whose vibration is to be damped and being subject to heat of the internal combustion engine; an independent mass member housed within the hollow space of the rigid housing with an empty space formed between an inner surface of the housing and an outer surface of the independent mass member over an entire circumference thereof as seen in transverse cross sections of the rigid housing and the independent mass member, said independent mass member being resiliently displaced to come into impact against the housing upon input of vibration; and a rubber sleeve being independent of the housing and the independent mass member, and being disposed within the empty space so as to extend over an entire circumference of the empty space with a constant thickness dimension, wherein, at room temperature of 25° C., an inside tiny gap is formed between an inner circumferential surface of the rubber sleeve and the outer surface of the independent mass member over an entire circumference thereof, and an outside tiny gap is formed between an outer circumferential surface of the rubber sleeve and the inner surface of the housing over an entire circumference thereof.

In the vibration damping device for use in an internal combustion engine constructed according to the present invention, the independent mass member strikes against the housing via the rubber sleeve by means of its resilient displacement permitted within the inside tiny gap and the outside tiny gap. The vibration damping device is characterized, for example, in that: (1) the rubber sleeve is more likely to undergo shearing deformation as well as compressive deformation when the independent mass member strikes against the housing; (2) friction is effectively produced during contact between the independent mass member and the housing; and (3) the independent mass member strikes against the housing on the opposite sides thereof in the resilient displacement direction. For these characteristics, the present vibration damping device will advantageously exhibit vibration damping action based on energy loss through sliding friction or impact.

Meanwhile, a study of working environment of the present vibration damping device conducted by the inventors has revealed some phenomenon. For example, since the target members whose vibration is to be damped are the components of the internal combustion engine or the components furnished around the internal combustion engine, the vibration damping device is likely to be exposed to heat of the internal combustion engine or environmental temperature of the external air. In the certain working environment, the rubber sleeve may dilate to a large extent due to the difference between dilatation of the rubber sleeve and dilatation of the housing or the independent mass member, thereby coming into contact with both the independent mass member and the housing. As a result, the tiny space between the independent mass member and the housing may become eliminated. This may possibly cause deterioration in resilient displacement of the independent mass member, whereby an intended vibration damping action on the basis of striking action of the independent mass member against the housing would not be consistently attained.

With this respect, it should be noted that the vibration damping device of the present invention has the aforementioned structure wherein, at room temperature of 25° C., the rubber sleeve is disposed between the independent mass member and the housing, with the inside tiny gap between the inner circumferential surface of the rubber sleeve and the outer surface of the independent mass member over the entire circumference thereof, and with the outside tiny gap between the outer circumferential surface of the rubber sleeve and the inner surface of the housing over the entire circumference thereof.

With this arrangement, even in the case where the rubber sleeve shrinks under the low-temperature environment, and the inner circumferential surface of the rubber sleeve comes into close contact with the outer surface of the independent mass member to thereby eliminate the inside tiny gap, the outside tiny gap is able to still exist. Likewise, even in the case where the rubber sleeve dilates under the high-temperature environment, and the outer circumferential surface of the rubber sleeve comes into close contact with the inner surface of the housing to thereby eliminate the outside tiny gap, the inside tiny gap is able to still exist.

According to the present invention, at least one of the inside and outside tiny gaps is maintained across a wide temperature range. Therefore, resilient displacement of the independent mass member can be consistently permitted under various kinds of environments, such as the high-temperature environment or the low-temperature environment, whereby striking action of the independent mass member against the housing can be effectively attained. Thus, the vibration damping device of the present invention free from or is less likely to suffer from adverse influence by the environment against its vibration damping action, thereby consistently exhibiting the intended vibration damping action.

It should be appreciated that the rubber sleeve is disposed between the independent mass member and the housing without being adhesive to either of them, and both the inside tiny gap and the outside tiny gap are formed over the entire circumference thereof at room temperature of 25° C. at least. This arrangement ensures a large degree of freedom of deformation of the rubber sleeve, whereby the rubber sleeve will provide resonance action of various modes. This phenomenon might be explained as follows: the resonance phenomenon of the rubber sleeve itself is more advantageously exhibited since the rubber sleeve is prevented from constraint due to adhesion to the independent mass member or the housing, whereby attenuating action in association with elastic deformation of the rubber sleeve can be more effectively attained.

Additionally, the resonance phenomenon of the rubber sleeve is exhibited in a plurality of modes over a variety of frequency bands, so that effective vibration damping action against vibration in a wide frequency band can be exhibited. Accordingly, the vibration damping device of the present invention is able to realize broadening vibration damping action more advantageously in comparison with vibration damping devices of conventional construction where a rubber layer is bonded onto an inner surface of a housing or an outer surface of an independent mass member.

In one preferred form of the vibration damping device for use in an internal combustion engine according to the present invention, the inner surface of the housing, the inner and outer circumferential surfaces of the rubber sleeve, and the outer surface of the independent mass member are of circular shape in transverse cross section, and the inside tiny gap and the outside tiny gap are of annular shape with the independent mass member, the rubber sleeve and the housing are located in a concentric fashion. In this preferred form, the rubber sleeve will undergo pure compression deformation at a relatively small area in the striking direction of the independent mass member against the housing, and will undergo shear deformation at the area having gradually changing slopes. This arrangement permits easily attaining attenuating action based on shearing deformation of the rubber sleeve, while ensuring various spring properties exhibited based on respective portions of the rubber sleeve. Thus, vibration damping action is more effectively exhibited in a wide frequency band. Additionally, since the inner surface of the housing, the inner and outer circumferential surfaces of the rubber sleeve, and the outer surface of the independent mass member are of circular shape in transverse cross section, the vibration damping device of this preferred form can be readily manufactured in comparison with the case where these components are of rectangular shape or other possible shapes in transverse cross section.

In further preferred form of the vibration damping device for use in an internal combustion engine according to the present invention, the inside tiny gap and the outside tiny gap have respective gap dimensions a sum of which is held within a range of 0.01-0.2 mm with a state where the independent mass member and the rubber sleeve are held in first strike ends thereof in their displacement relative to the housing. Experimentations conducted by the inventors have revealed that, the vibration damping device of this preferred form will exhibit sufficient vibration damping action on the basis of striking action of the independent mass member against the housing via the inside and outside tiny gaps at room temperature.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is a transverse cross sectional view of a vibration damping device for an automotive vehicle of construction according to a first embodiment of the invention;

FIG. 2 is a cross sectional view taken along line 2-2 of FIG. 1;

FIG. 3 is a transverse cross sectional view of a vibration damping device of the invention, in one state different from the state shown in FIG. 1;

FIG. 4 is a graph demonstrating a result of measurements relating to vibration damping action by means of a vibration damping device of the invention under a prescribed condition;

FIG. 5 is a graph demonstrating a result of measurements relating to vibration damping action by means of a vibration damping device of the invention under another condition;

FIG. 6 is a graph demonstrating a result of measurements relating to vibration damping action by means of a vibration damping device of the invention under yet another condition;

FIG. 7 is a graph demonstrating a result of measurements relating to vibration damping action by means of a vibration damping device of the invention under still yet another condition;

FIG. 8 is a transverse cross sectional view of a vibration damping device of construction according to another preferred embodiment of the invention;

FIG. 9 is a transverse cross sectional view of a vibration damping device of construction according to yet another preferred embodiment of the invention;

FIG. 10 is a transverse cross sectional view of a vibration damping device of construction according to still another preferred embodiment of the invention;

FIG. 11 is a transverse cross sectional view of a vibration damping device of construction according to a further preferred embodiment of the invention; and

FIG. 12 is a transverse cross sectional view of a vibration damping device of construction according to a still further preferred embodiment of the invention.

### DETAILED DESCRIPTION OF PREFERRED EMBODIMENTS

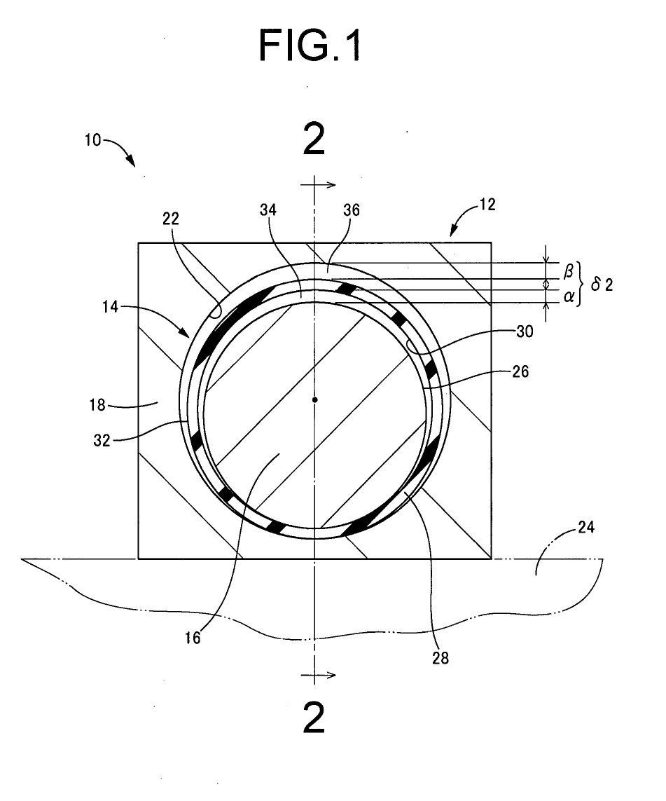

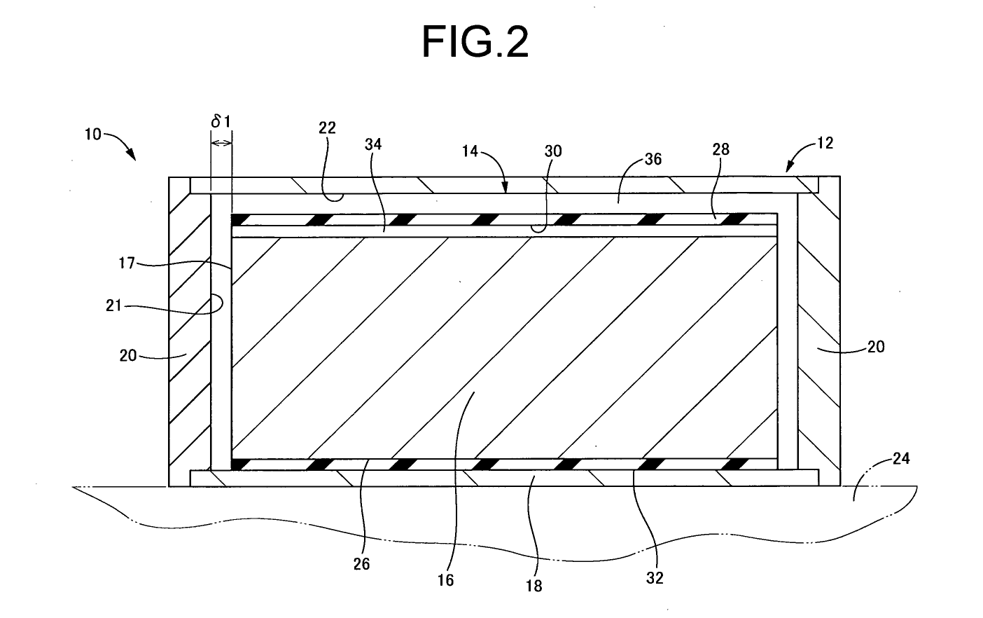

FIGS. 1 and 2 depict a vibration damping device 10 for an automotive vehicle according to a first embodiment of the invention. The vibration damping device 10 has a structure composed of an accommodation space 14 serving as a hollow space formed by a housing 12 and a mass member 16 serving as an independent mass member accommodated within the accommodation space 14. Upon application of vibrations to the housing 12, the mass member 16 elastically comes into impact against the housing 12, thereby attaining the vibration damping action.

Described in detail, the housing 12 includes a housing body 18 and a pair of cover members 20, 20. The housing body 18 is of longitudinal, generally rectangular block shape and is provided at its center portion with a center hole which extends in a longitudinal direction (sideways in FIG. 2) with a constant circular cross section and opens at the longitudinally opposite ends of the housing body 18. An inner circumferential wall face of this circular center hole forms an inner surface 22 of the housing body 18.

Each cover member 20 has a generally circular disk shape, whose outer peripheral portion is superposed against and secured to a corresponding opening edge of the housing body 18 by welding, bonding, or the like. With this arrangement, the opposite ends of the housing body 18 are covered by the cover members 20, respectively, thereby composing the housing 12. The housing 12 includes therein the accommodation space 14 extending in an axial direction parallel with the longitudinal direction (sideways in FIG. 2) with a constant circular cross section.

A peripheral wall of the housing body 18 is superposed against a vibrating member 24, i.e a target member whose vibration is to be damped, and is secured to the vibrating member 24 by bolting, welding, or other fixing means. With this arrangement, the housing 12 is fixed to the vibrating member 24. The vibrating member 24 will be described later in detail.

The mass member 16 is of cylindrical shape with its axial length smaller than an axial dimension of the accommodation space 14, and with its diameter dimension smaller than an axis-perpendicular dimension of the accommodation space 14.

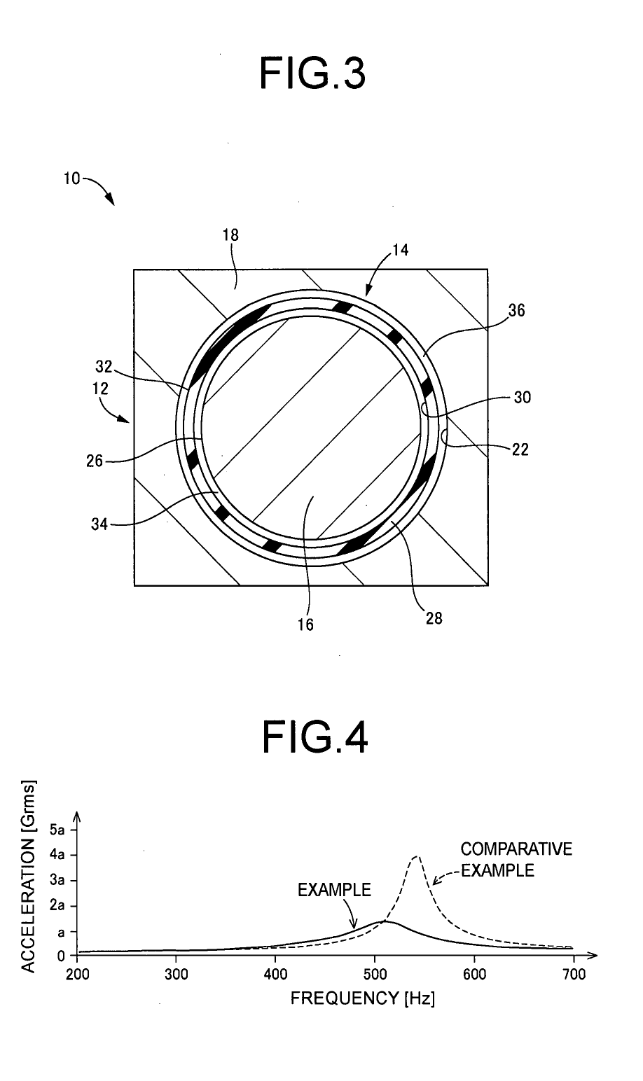

In other words, the mass member 16 is positioned accommodated within the accommodation space 14 of the housing 12 without being adhesive to the housing 12. As shown in FIG. 3, with the housing 12 and the mass member 16 being located in a concentric fashion, there is formed an empty space of substantially unchanging size between the outer surface 26 of the mass member 16 and the inner surface 22 of the housing body 18 over an entire circumference thereof.

Meanwhile, with an axial center portion of the mass member 16 being positioned in an axial center portion of the accommodation space 14 (see FIG. 2), there is formed a spacing of prescribed dimension: δ1 between an axial end surface 17 of the mass member 16 and an inner surface 21 of the cover member 20. Namely, the dimension δ1 represents an axial spacing between the axial end surface 17 of the mass member 16 and the inner surface 21 of the cover member 20 in the state of the vibration damping device 10 as seen in a vertical cross section, as shown in FIG. 2.

The housing 12 and the mass member 16 are formed of a material having a sufficiently high rigidity including steel, aluminum alloy, or the like. In order to attain effective vibration damping action, a high gravity material such as steel is employed as a material of the mass member 16. The housing 12 may be formed of a rigid synthetic resin material or the like, preferably a synthetic resin material having a modulus of elasticity of 5×10⁴ MPa or more.

A tubular rubber 28 serving as a rubber sleeve is disposed between the inner surface 22 of the housing 12 (the housing body 18) and the outer surface 26 of the mass member 16. The tubular rubber 28 has a thin, round tubular shape extending in the axial direction. A material for the tubular rubber 28 may be preferably selected from natural rubber, styrene-butadiene rubber, isoprene rubber, acrylonitrile-butadiene rubber, chloroprene rubber, butyl rubber, or a composite material thereof, for example. The tubular rubber 28 may preferably have a Shore D hardness of 80 or lower, more preferably, within a range of 20-40, as measured in accordance with ASTM method D-2240 so as to effectively attain vibration damping action on the basis of striking action of mass member 16 against the housing 12 or noise reducing effect upon striking.

In particular, the tubular rubber 28 is formed such that a diameter dimension of an inner circumferential surface 30 which represents an inside diameter dimension of the tubular rubber 28 is larger than a diameter dimension of the outer surface 26 of the mass member 16, while a diameter dimension of an outer circumferential surface 32 which represents an outside diameter dimension of the tubular rubber 28 is smaller than a diameter dimension of the inner surface 22 of the housing 12.

The tubular rubber 28 of construction as described above is positioned accommodated between the inner surface 22 of the housing 12 and the outer surface 26 of the mass member 16 without being adhesive to either of them, with internally located within the housing 12 as well as externally located around the mass member 16. In this state, as shown in FIG. 3, namely, with the mass member 16, the tubular rubber 28, and the housing 12 being placed in a concentric fashion, there is formed an inside tiny gap 34 of substantially unchanging size between the inner circumferential surface 30 of the tubular rubber 28 and the outer surface 26 of the mass member 16 over an entire circumference thereof. Also, there is formed an outside tiny gap 36 of substantially unchanging size between the outer circumferential surface 32 of the tubular rubber 28 and the inner surface 22 of the housing body 18 over an entire circumference thereof. The inside tiny gap 34 and the outside tiny gap 36 are of annular shape in the state shown in FIG. 3.

In this embodiment in particular, in an initial state where no vibration is applied to the vibration damping device 10, the mass member 16 and the tubular rubber 28 are superposed against each other on the lower side of the accommodation space 14 and are held in contact with the housing body 18 due to the gravity acting (see FIG. 1). Namely, in the initial state shown in FIG. 1, the independent mass member and the rubber sleeve are held or located in their first strike ends or bottom strike ends in their displacement direction with respect to the housing. In this state, a sum: δ2 of a dimension: α of the inside tiny gap 34 and a dimension: β of the outside tiny gap 36 (α+β=δ2), as measured on an axis-perpendicular line passing through a center axis of the accommodation space 14 and extending in the vertical direction, is held within a range of 0.01-0.2 mm, preferably at 0.05 mm, at room temperature of 25° C. Consequently, with the mass member 16 and the tubular rubber 28 being located in a concentric fashion (see FIG. 3), a sum of dimensions of the inside tiny gap 34 and the outside tiny gap 36 as measured on the same axis-perpendicular line at one of diametrically opposite side is held at δ2/2. That is, the dimension of the inside tiny gap 34 refers to a sum of diametrical spacings formed between the outer surface 26 of the mass member 16 and the inner circumferential surface 30 of the tubular rubber 28 at diametrically opposite sides on the same axis-perpendicular line passing through the center axis of the vibration damping device 10 while extending vertically as seen in transverse cross section, shown in FIGS. 1 and 3, for example. Likewise, the dimension of the outside tiny gap 36 refers to a sum of diametrical spacings formed between the outer circumferential surface 32 of the tubular rubber 28 and the inner surface 22 of the housing body 18 at diametrically opposite sides on the same axis-perpendicular line passing through the center axis of the vibration damping device 10 while extending vertically. Also, by measuring a diameter dimension of the outer circumferential surface 32 of the tubular rubber 28 as well as a wall thickness of the tubular rubber 28 with a laser beam, for instance, it is possible to measure a diameter dimension of the inner circumferential surface 30 of the tubular rubber 28, or the like. The dimension of the inside tiny gap 34 and the dimension of the outside tiny gap 36 can be established with high accuracy by measuring diameter dimensions of these inner and outer circumferential surfaces 30, 32 of the tubular rubber 28, the inner surface 22 of the housing 12, and the outer surface 26 of the mass member 16 with high accuracy.

With the arrangement as described above, the mass member 16 is displaceable by a distance equivalent to δ2 in the axis-perpendicular direction within the accommodation space 14. In addition, the mass member 16 is further displaceable from the state where the mass member 16 abuts on the housing body 18 via the tubular rubber 28 to the state where the tubular rubber 28 undergoes compressive deformation between the mass member 16 and the housing body 18. As will be apparent from the above description, the mass member 16 is independently displaceable relative to the inside surface of the housing 12 which forms the accommodation space 14, while coming into abutment with the housing 12 via the tubular rubber 28.

In the vibration damping device 10 of this construction, the peripheral wall of the housing 12 is superimposed against and fixed to the vibrating member 24 on a vehicle body side by bolting, welding, or other fixing means, so that the axial direction of the vibration damping device 10 (sideways in FIG. 2) extends parallel to the plane of the vibrating member 24 on which the vibration damping device 10 is fixed.

With the vibration damping device 10 installed as stated above, when vibration of the vibrating member 24 is input to the housing 12, the mass member 16 independently undergoes resilient displacement relative to the housing 12 in the vibration input direction and strikes against the housing body 18 or the cover member 20 via the tubular rubber 28. Consequently, vibration damping action on the basis of energy loss or sliding friction through impact of the mass member 16 against the housing 12 is attained.

In this embodiment in particular, the inner surface 22 of the housing body 18, the outer and inner circumferential surfaces 32, 30 of the tubular rubber 28, and the outer surface 26 of the mass member 16 are of circular shape in transverse cross section. This arrangement makes it possible to minimize the area of the compression deformed part of the tubular rubber 28 in the vibration input direction. In the position away from the primary vibration input direction of the mass member 16 and the housing body 18, the tubular rubber 28 will undergo shearing deformation while being sandwiched between the mass member 16 and the housing body 18. In the present embodiment, this sealing deformation part of the tubular rubber 28 has a slope gradually varying owing to the circular shape in transverse cross section.

In addition, the tubular rubber 28 is disposed without being adhesive to either the housing 12 or the mass member 16, thereby assuring a large degree of freedom of deformation of the tubular rubber 28, and a sufficient effective surface area of the tubular rubber 28 with respect to sliding friction with the housing 12 or the mass member 16, as well.

Consequently, the tubular rubber 28 will exhibit resonance action of various modes, and accordingly provides attenuating action based on its shearing deformation with further efficiency while exhibiting rubber resonance on multiple frequencies or in a wide frequency band. Thus, the vibration damping device 10 of the present invention is able to realize broadening vibration damping action more advantageously in comparison with vibration damping devices constructed according to a conventional manner where an outer surface of a mass member or an inner surface of a housing is covered with a rubber layer.

Meanwhile, the vibrating member 24 is a frame of a vehicle body or the like which is furnished around the internal combustion engine including a power unit, a transmission, and so forth. Therefore, a temperature of the vibration damping device 10 mounted on the vibrating member 24 sometimes considerably rises from a relatively low temperature as low as 0° C. or a room temperature of 25° C. up to a relatively high temperature as high as 80° C. or over, for example, due to heat of the internal combustion engine. As a result, the tubular rubber 28 dilates and undergoes expansion deformation outwardly in the diametrical direction due to the difference between dilatation of the tubular rubber 28 and dilatation of the housing 12 or the mass member 16.

Specifically, a dilatation: γ (%) of rubber material which constitutes the tubular rubber 28 is represented by a simple equation, Eq. (1), given below.

γ=240×10⁻⁴×t Eq. (1)

(With the proviso that t (° C.) represents a temperature difference at a constant pressure)

For instance, in the case where a temperature rises from 20° C. to 110° C. at a constant pressure, the temperature difference is 90° C. Therefore, the dilatation: γ of the tubular rubber 28 is calculated to be 2.16% by Eq. (1).

In this embodiment, the tubular rubber 28 has a thickness dimension of 1.5 mm, while the outside tiny gap 36 has a dimension: β of not greater than 0.03 mm with the mass member 16, the tubular rubber 28, and the housing body 18 being placed in a concentric fashion.

Consequently, in the case where the temperature difference is 90° C. as described above, the tubular rubber 28 increases its thickness by a dimension: i (mm), which is calculated as follows: i=1.5×0.0216=0.0324. This means that the tubular rubber 28 increases its thickness in association with the thermal expansion thereof by a dimension exceeding the dimension of the outside tiny gap 36, whereby the outer circumferential surface 32 of the tubular rubber 28 comes into contact with the inner surface 22 of the housing body 18, thereby eliminating the outside tiny gap 36.

Even in this condition, since the tubular rubber 28 is accommodated between the housing body 18 and the mass member 16 without being adhesive to either of them with the inside tiny gap 34 between the inner circumferential surface 30 of the tubular rubber 28 and the outer surface 26 of the mass member 16, the inside tiny gap 34 increases its size by an amount corresponding to the amount by which the outside tiny gap 36 decreases its size. Therefore, in the case where the outer circumferential surface 32 of the tubular rubber 28 comes into contact with the inner surface 22 of the housing body 18 to eliminate the outside tiny gap 36, a sufficient size of the inside tiny gap 34 is assured. Namely, under a high-temperature environment where the tubular rubber 28 undergoes expansion deformation, the inside tiny gap 34, serving as a gap which permits resilient displacement of the mass member 16, can reliably be maintained between the diametrically opposed housing body 18 and mass member 16.

Likewise, the vibration damping device 10 according to this embodiment may be operated under a low temperature. In this case, the tubular rubber 28 may undergo shrinkage deformation inwardly in the diametrical direction. In association with this shrinkage deformation of the tubular rubber 28, the inside tiny gap 34 decreases its size, whereby the inner circumferential surface 30 of the tubular rubber 28 comes into contact with the outer surface 26 of the mass member 16 to sometime cause an elimination of the inside tiny gap 34.

Even in this condition, since the inside tiny gap 34 and the outside tiny gap 36 are formed to an inside and the outside of the tubular rubber 28, respectively, within a space between the housing body 18 and the mass member 16 the outside tiny gap 36 increases its size by an amount corresponding to the amount by which the inside tiny gap 34 decreases its size. Therefore, in the case where the inner circumferential surface 30 of the tubular rubber 28 comes into contact with the outer surface 26 of the mass member 16 to eliminate the inside tiny gap 34, a sufficient size of the outside tiny gap 36 is assured. Namely, under a low-temperature environment where the tubular rubber 28 undergoes shrinkage deformation, the outside tiny gap 36, serving as a gap which permits resilient displacement of the mass member 16, can reliably be maintained between the diametrically opposed housing body 18 and mass member 16.

That is, at least one of the inside and outside tiny gaps 34, 36 is maintained between the mass member 16 and the housing body 18 across a wide temperature range, consistently producing resilient displacement of the mass member 16 under various kinds of environments, such as the high-temperature environment or the low-temperature environment, whereby striking action of the mass member 16 against the housing 12 can be effectively attained. Thus, the vibration damping device 10 is free from or is less likely suffer from adverse influence by the environment against vibration damping action, thereby exhibiting the intended vibration damping action consistently.

In short, the vibration damping device 10 constructed according to this embodiment can enjoy excellent technical achievements that the tubular rubber 28 is accommodated within the accommodation space 14 between the mass member 16 and the housing 12 without being adhesive to either of them by means of the inside and outside tiny gaps 34, 36, whereby striking action can consistently be attained under the various kinds of environment, and effective vibration damping action against vibration in a wide frequency band can be attained as well by allowing the tubular rubber 28 to exhibit various resonance modes.

While the present invention has been described in detail in its presently preferred embodiment, for illustrative purpose only, it is to be understood that the invention is by no means limited to the details of the illustrated embodiment, but may be otherwise embodied. It is also to be understood that the present invention may be embodied with various changes, modifications and improvements which may occur to those skilled in the art, without departing from the spirit and scope of the invention.

For example, the shape, size, construction, number, placement and other aspects of the housing 12, the mass member 16, the tubular rubber 28, or the inside and outside tiny gaps 34, 36 are not limited to those taught herein by way of example.

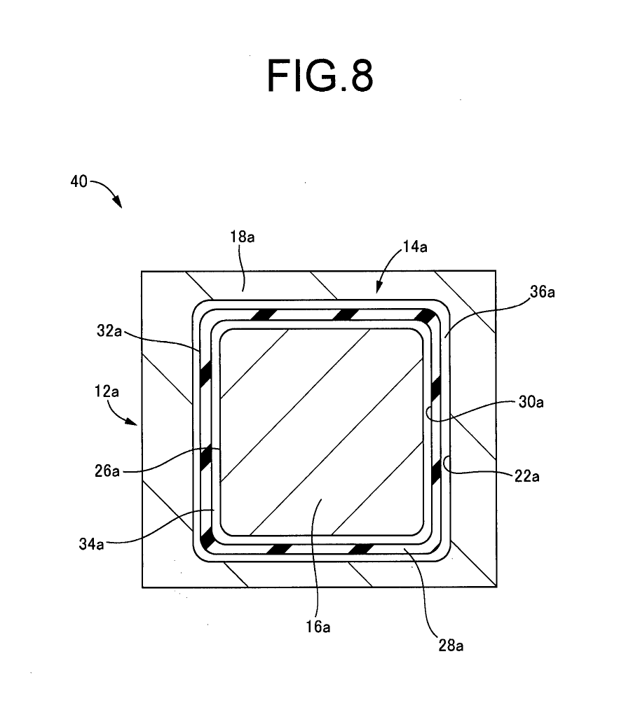

Specifically, whereas in the embodiment described above the inner surface 22 of the housing body 18, the outer surface 26 of the mass member 16, the inner and outer circumferential surface 30, 32 of the tubular rubber 28 are of circular shape in transverse cross section, these could alternatively be of rectangular shape or the like in transverse cross section, as disclosed in FIG. 16 of JP-A-2004-301219, for example. In this state, the inside tiny gap 34 and the outside tiny gap 36 are of rectangular shape in transverse cross section. FIG. 8 shows a vibration damping device 40 of construction as stated above.

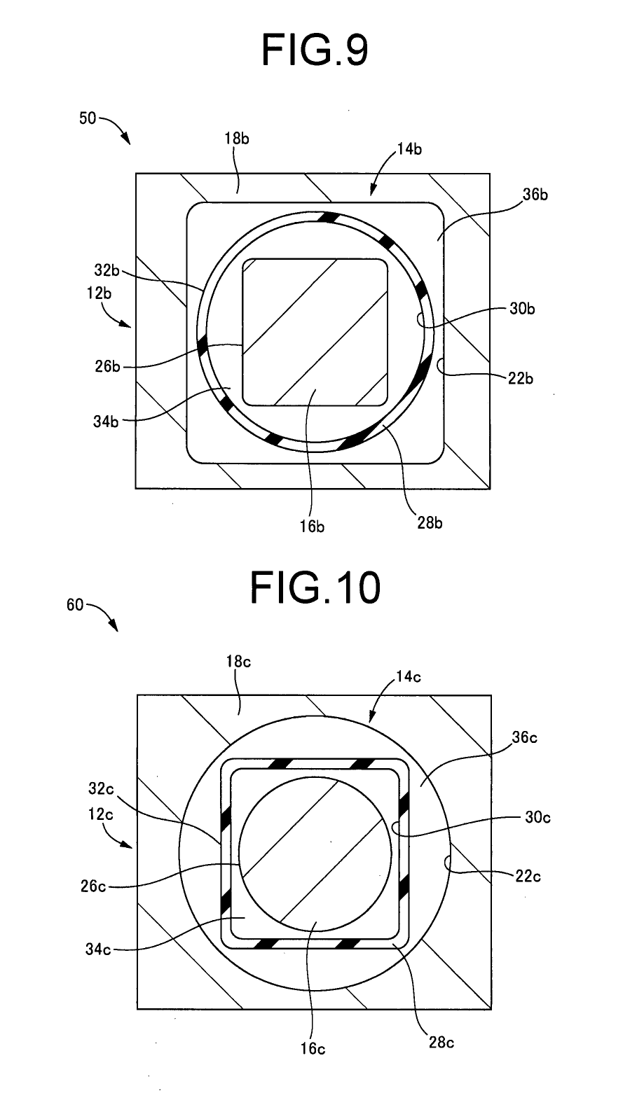

It could also be possible, for example, that the tubular rubber 28 of round tubular shape is positioned accommodated between the inner surface 22 of the housing body 18 and the outer surface 26 of the mass member 16 which both are of rectangular shape in transverse cross section, or the tubular rubber 28 of rectangular tubular shape is positioned accommodated between the inner surface 22 of the housing body 18 and the outer surface 26 of the mass member 16 which both are of circular shape in transverse cross section. FIGS. 9 and 10 show vibration damping devices 50, 60 of construction as stated above.

In other words, the size of the inside and outside tiny gaps 34, 36 is not limited to be constant over the entire circumference. That is, in the embodiment described above, the inside tiny gap 34 and the outside tiny gap 36 are extending with substantially unchanging size over the entire circumference with the mass member 16, the tubular rubber 28, and the housing 12 being placed in a concentric fashion. However, for example, in the case where the inner surface 22 of the housing body 18, the outer surface 26 of the mass member 16, or the inner and outer circumferential surface 30, 32 of the tubular rubber 28 is not of circular shape in transverse cross section or is of warping shape, those tiny gaps 34, 36 do not need to be formed with a constant size.

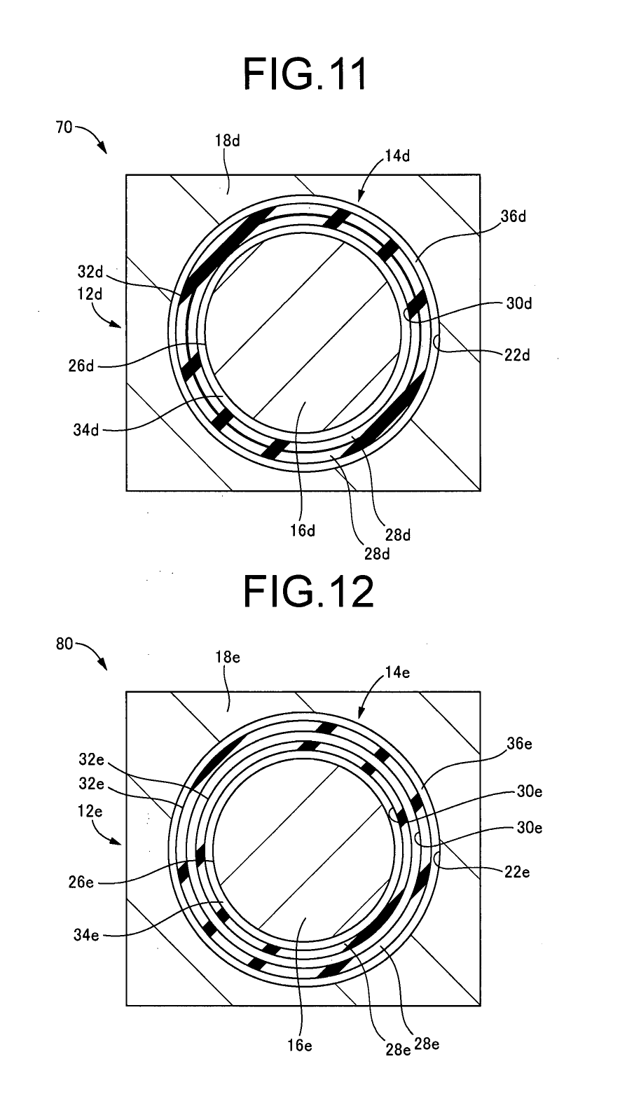

In the embodiment described above, one tubular rubber 28 is disposed between the mass member 16 and the housing 12. Alternatively, a plurality of tubular rubbers 28 being placed in a concentric fashion can be disposed, for example, or furthermore a plurality of tiny gaps can be formed between the mass member 16 and the housing 12 by means of forming tiny gaps among the plurality of tubular rubbers 28. FIGS. 11 and 12 show vibration damping devices 70, 80 of construction as stated above. These vibration damping devices 40, 50, 60, 70 and 80, of course, can enjoy the advantages of the present invention that has been discussed above with respect to the first embodiment.

The principle of the present invention is favorably employed not only by the vibration damping device 10 for an automotive vehicle applicable to an internal combustion engine of an automotive vehicle according to the illustrated embodiment, but also by a various kinds of targets other than automotive vehicles whose vibration is to be damped, which are furnished with an internal combustion engine.

### EXAMPLES

Following is a description of an example of the invention for the purpose of demonstrating the vibration damping action of the vibration damping device 10 according to the present invention. However, the invention should not be construed as limited to these examples.

First, a base as a vibrating member (not shown) was set up. The base was fabricated of rigid material such as iron and was secured to a vibration exciter (not shown). The base was subjected to sweep excitation and sine wave excitation by the vibration exciter, or to impact excitation by an impulse hammer at a prescribed location on the base. The primary vibration mode of the base was examined by mode analysis such as FEM (Finite Element Method), as well as measuring the primary natural frequency: F of the base.

The vibration damping device 10 according to the first embodiment described above was secured to the base at a suitable location. The primary natural frequency: f of the vibration damping device 10 was set to a frequency substantially identical with the primary natural frequency: F of the base.

With the vibration damping device 10 secured to the base, a prescribed excitation force was applied to the base with the vibration exciter or the impulse hammer, and the resultant vibration level (dB) was measured with a laser vibration gauge of known type. Resultant measurements of vibration level of the base with the vibration damping device 10 fixed are demonstrated as Example in the graph of FIG. 4. Also in the graph of FIG. 4, resultant measurements for the base in the absence of the vibration damping device 10 are demonstrated as Comparative Example.

Vibration level of the base in the Example and Comparative Example was measured at room temperature of 25° C. The mass of the base was 1100 g and the mass of the vibration damping device 10 was 100 g. In particular, in the state shown in FIG. 1 where the mass member 16 and the tubular rubber 28 are superposed against each other on the lower side of the accommodation space 14 and are held in contact with the housing body 18 due to the gravity acting, a sum: δ2 of a dimension: α of the inside tiny gap 34 and a dimension: β of the outside tiny gap 36, namely, α+β=δ2, was held at 0.1 mm, at room temperature of 25° C.

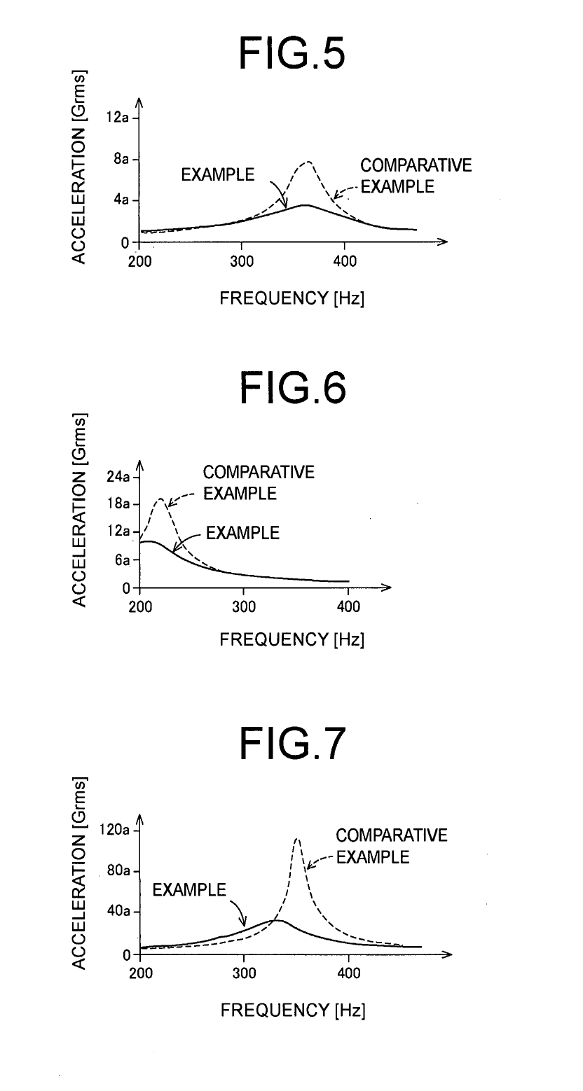

Additional measurements were conducted with the vibration damping device 10 secured to the base by applying three different excitation forces which are several to dozens of times that in the experiment shown in FIG. 4, and the resultant vibration level (dB) was measured. Resultant measurements at respective excitation forces are demonstrated as Example in FIGS. 5, 6, and 7 respectively. Also in FIGS. 5, 6, and 7, resultant measurements for the base in the absence of the vibration damping device 10 upon application of the three different excitation forces are demonstrated as Comparative Example, respectively.

As will be understood from the results shown in the graphs of FIGS. 4, 5, 6, and 7, the vibration damping device 10 according to the Example of the present invention can exhibit excellent vibration damping action against vibrations which have amplitudes ranging from a small amplitude to a large amplitude. The reason for these effects might be considered as follows: the tubular rubber 28 is positioned accommodated within the accommodation space 14 between the mass member 16 and the housing 12 without being adhesive to either of them by means of the inside and outside tiny gaps 34, 36, whereby vibration damping action based on consistent striking action can be attained, and effective vibration damping action against vibration in a wide frequency band can be attained as well by allowing the tubular rubber 28 to exhibit various resonance modes.

What is claimed is:

1. A vibration damping device for use in an internal combustion engine, comprising:
a rigid housing having a hollow space, and adapted to be fixed to a target member whose vibration is to be damped and being subject to heat of the internal combustion engine;
an independent mass member housed within the hollow space of the rigid housing with an empty space formed between an inner surface of the housing and an outer surface of the independent mass member over an entire circumference thereof as seen in transverse cross sections of the rigid housing and the independent mass member, said independent mass member being resiliently displaced to come into impact against the housing upon input of vibration; and
at least one rubber sleeve being independent of the housing and the independent mass member, and being disposed within the empty space so as to extend over an entire circumference of the empty space with a constant thickness dimension,
wherein, at room temperature of 25° C., an inside tiny gap is formed between an inner circumferential surface of the rubber sleeve and the outer surface of the independent mass member over an entire circumference thereof, and an outside tiny gap is formed between an outer circumferential surface of the rubber sleeve and the inner surface of the housing over an entire circumference thereof.

2. The vibration damping device according to claim 1, wherein the inner surface of the housing, the inner and outer circumferential surfaces of the rubber sleeve, and the outer surface of the independent mass member are of circular shape in transverse cross section, and the inside tiny gap and the outside tiny gap are of annular shape with the independent mass member, the rubber sleeve and the housing are located in a concentric fashion.

3. The vibration damping device according to claim 1, wherein the inside tiny gap and the outside tiny gap have respective gap dimensions a sum of which is held within a range of 0.01-0.2 mm as measured on an axis-perpendicular line passing through a center axis of the hollow space and extending in a vertical direction with a state where the independent mass member and the rubber sleeve are held in first strike ends thereof in their displacement relative to the housing.

4. The vibration damping device according to claim 1, wherein the inner surface of the housing, the inner and outer circumferential surfaces of the rubber sleeve, and the outer surface of the independent mass member are of rectangular shape in transverse cross section, and the inside tiny gap and the outside tiny gap are of rectangular shape in transverse cross section with the independent mass member, the rubber sleeve and the housing are located in a concentric fashion.

5. The vibration damping device according to claim 1, wherein the inner surface of the housing and the outer surface of the independent mass member are of rectangular shape, and the inner and outer circumferential surfaces of the rubber sleeve are of circular shape in transverse cross section.

6. The vibration damping device according to claim 1, wherein the inner surface of the housing and the outer surface of the independent mass member are of circular shape, and the inner and outer circumferential surfaces of the rubber sleeve are of rectangular shape in transverse cross section.

7. The vibration damping device according to claim 1, wherein the at least one rubber sleeve comprises a plurality of the rubber sleeves disposed within the empty space, while being located in a concentric fashion.

8. The vibration damping device according to claim 7, wherein the plurality of the rubber sleeves are mutually spaced away from one another.
